(19) United States
(12) Patent Application Publication
(10) Pub. No.: US 2007/0159529 A1
(43) Pub. Date: Jul. 12, 2007

(54) Method and apparatus for controlling output of a surveillance image

(75) Inventor: Jin Mo Park, Gwangmyung-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/635,640

(22) Filed: Dec. 8, 2006

(30) Foreign Application Priority Data
Dec. 9, 2005 (KR) 10-2005-0120396

(51) Int. Cl. H04N 7/18

(52) U.S. Cl. 348/143

(57) ABSTRACT

A method and apparatus for controlling the output of a surveillance image, are discussed. According to an embodiment, the method includes checking whether an event is detected in at least one inputted surveillance image; and if the event is detected, determining whether to switch over to a surveillance image in which the event is detected, from a first surveillance image currently being displayed.

This application claims priority to the Korean Patent Application No. 10-2005-0120396, filed in Korea on Dec. 9, 2005, which is hereby incorporated by reference in its entirety.

### BACKGROUND OF TE INVENTION

1. Field of the Invention

The present invention is related to a method and apparatus for outputting a surveillance image being captured.

2. Background of the Related Art

Generally, a surveillance apparatus, being installed at a particular area which needs to be monitored (e.g., bank, museum, etc.), captures the scene of the corresponding area and stores the signals of captured images intermittently. FIG. 1 illustrates a simplified structure of such a surveillance apparatus according to a related art. As illustrated, the surveillance apparatus usually comprises a surveillance camera 100 capturing a scene, a digital video recorder (DVR) 200 which stores the captured images and is installed at a remote place, and a monitor 150 displaying the captured images.

An image obtained from a surveillance area designated by the field of view of the surveillance camera 100 (hereinafter referred to as ‘surveillance image’) is recorded in the DVR 200 as well as being displayed at the monitor 150.

Generally, a surveillance apparatus obtains surveillance images simultaneously from several monitoring areas by installing a number of surveillance cameras including the surveillance camera 100. As illustrated in FIG. 2, multiple surveillance images obtained as above are generally displayed on a single screen, by splitting the screen of the monitor 150. The DVR 200 manages each of the different surveillance images obtained from the different surveillance cameras as a single channel and carries out the function of composing and displaying multiple surveillance images received from such channels as a single multi-view screen. Therefore, the monitor 150 is usually connected to a video output port of the DVR 200. The selection of or the display method for a surveillance image to be fed to the monitor 150 is done by an operator selecting a function provided by the DVR 200.

When the multiple surveillance images are composed into a single multi-view screen output, which is fed to the monitor 150, it becomes possible to watch and monitor all the surveillance images in real-time on a single screen as shown in FIG. 2. By the way, when there is a certain monitoring area which requires attention at the existence of a motion, a motion event mode can be set. When this mode is set, the DVR 200 detects a motion component (which is called as a ‘motion’ hereinafter) in the surveillance images received from the surveillance cameras. At the same time, the DVR 200 records the image frames of the corresponding channel before and/or after the time of the motion detection, thereby enabling an operator to check when and from which channel the motion has been detected by playing back the surveillance images of each recorded channel at his/her own convenience.

However, even with the motion event mode set, when the operator does not monitor a multi-view surveillance image of multiple channels but monitors a single surveillance image of a particular channel in full screen as shown in FIG. 3 and a motion happens in a surveillance image of a different channel, since the surveillance image of the motion-detected channel is not displayed on the screen, the surveillance image of the motion-detected channel is only recorded in the DVR 200 and cannot be noticed by the operator at that time because the monitor 150 continuously displays the surveillance images of only the current channel in which no motion is detected. As a result, the operator cannot immediately check the corresponding monitored area at or around the occurrence of the motion and thus, such a surveillance technique is inadequate and fails to prevent crimes and undesirable events. Further, although the cause of the motion may be identified by the subsequent playback of recorded images of the motion-detected channel, the operator loses the opportunity to view and/or investigate the cause of the motion in real time or in substantially real time. Moreover, if for some reason, the recording of the motion-detected channel is not properly made, then there would be a complete loss of invaluable information needed to investigate the cause of the motion.

### SUMMARY OF THE INVENTION

The present invention provides a method and apparatus for enabling an operator to recognize a situation under arbitrary circumstances when the situation requires attention and viewing of a surveillance image.

An object of the present invention is to provide a surveillance method and apparatus that address the limitations and disadvantages associated with the related art.

A method for controlling the output of a surveillance image in accordance with an embodiment of the present invention checks whether an event is detected from an input surveillance image, and when the event is detected, determines whether to switch over to the surveillance image where the event has been detected, from a first image being displayed.

Another method for controlling output of a surveillance image in accordance with an embodiment of the present invention checks whether an event is detected in an input surveillance image, and when the event is detected, composes an output screen in accordance with the number of surveillance images with the detected events.

In one example according to the present invention, an image change corresponding to a motion in a surveillance image is detected as the event.

In one example according to the present invention, when an event is detected, an output screen is automatically switched so that a surveillance image with the detected event is displayed.

In another example in accordance with the present invention, a user is notified of an event (e.g., a motion detection) and when the user requests a switchover, an output screen is switched so that a surveillance image with the detected event is displayed.

In a yet another example in accordance with the present invention, when an event is detected, a surveillance image with the detected event is displayed along with a surveillance image currently being displayed.

In one example in accordance with the present invention, when events are detected in multiple surveillance images, an output screen is equally divided so that the multiple surveillance images with the detected events are displayed at the same time or at the substantially same time.

In one example in accordance with the present invention, when a surveillance image being monitored on an output screen before the detection of an event and the surveillance image with the detected event are provided together on the output screen, additional indication information is displayed as being overlaid on the surveillance image of the detected event. In one example in accordance with the present invention, the additional indication information is character or graphic figure information blinking on the screen.

In one example in accordance with the present invention, when a surveillance image is provided in full screen, the existence of a surveillance image with a detected event is notified by indication information on a screen or by audio information.

In one example in accordance with the present invention, a method for switching over to a surveillance image with a detected event from a current output screen is determined based on preset information.

In one example in accordance with the present invention, it is checked whether an event is detected for all the input surveillance images.

In another example in accordance with the present invention, an event detection is checked only for those surveillance images designated for such event detection among input surveillance images.

According to an aspect of the present invention, there is provided a method for controlling an output of a surveillance image, comprising: checking whether an event is detected in at least one inputted surveillance image; and if the event is detected, determining whether to switch over to a surveillance image in which the event is detected, from a first surveillance image currently being displayed.

According to another aspect of the present invention, there is provided an apparatus for controlling an output of a surveillance image, comprising: a receiver configured to receive a plurality of surveillance images; and a processor configured to check whether an event is detected in at least one surveillance image among the received plurality of surveillance images, and if the event is detected, to determine whether to switch over to a surveillance image in which the event is detected, from a first surveillance image currently being displayed.

These and other objects and examples of the present invention will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, illustrate the preferred embodiments of the invention, and together with the description, serve to explain the principles of the present invention. In the drawings:

FIG. 1 illustrates a simplified structure of a surveillance apparatus;

FIG. 2 illustrates an example of a multi-view screen of a monitor for displaying surveillance images of multiple channels;

FIG. 3 illustrates an example of displaying a surveillance image of one arbitrary channel in full screen;

FIG. 4 illustrates a block diagram of a digital video recorder in accordance with one embodiment of the present invention;

FIG. 5 illustrates a flow diagram of a method for controlling the output of a surveillance image in accordance with one embodiment of the present invention;

FIGS. 6A through 6D illustrate various examples where a surveillance image of a channel with a detected motion is displayed on an output screen in accordance with an embodiment of the present invention; and

FIG. 7 illustrates a flow diagram of a method for controlling the output of a surveillance image in accordance with another embodiment of the present invention.

### DETAILED DESCRIPTION OF PREFERRED EMBODIMENTS

Hereinafter, according to the present invention, preferred embodiments will be described in detail with reference to appended drawings.

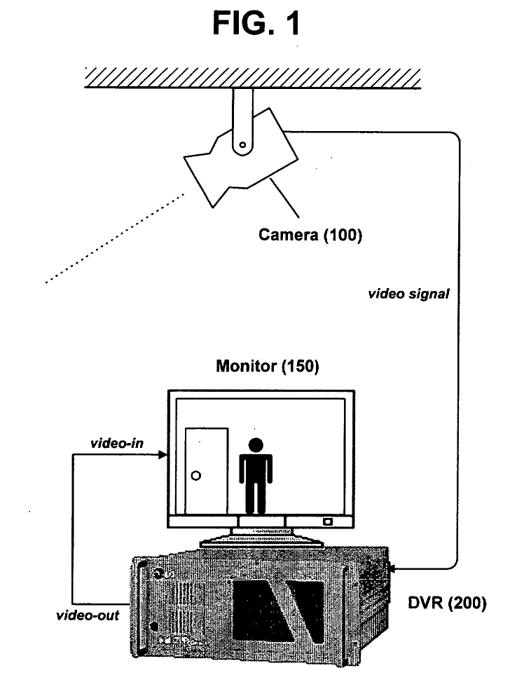

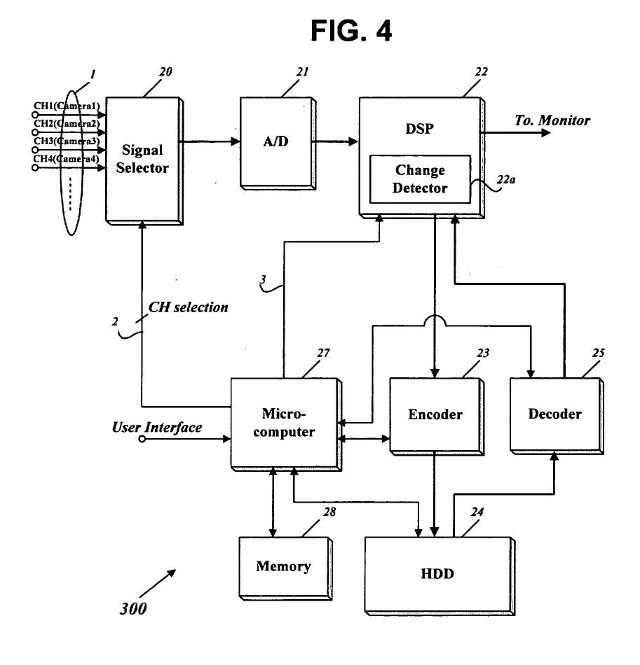

FIG. 4 illustrates a digital video recorder (DVR) 300 where a method for controlling the output of a surveillance image is implemented in accordance with one embodiment of the present invention. Also, the DVR 300 can be utilized in lieu of the DVR 200 in the environment of FIG. 1. The application of the present invention, however, is not limited to a particular apparatus and the present invention encompasses all the apparatuses where the ideas and purposes of the method for controlling the output of the surveillance image can be implemented.

The DVR 300 of FIG. 4 comprises a signal selector 20 selecting one or more input surveillance images from one or more input surveillance images (e.g., from one or more cameras or other image capturing devices), a A/D (analog-to-digital) converter 21 converting the selected signal to digital data, a digital signal processor (DSP) 22 processing the image data converted to digital data according to an operator's request, an encoder 23 encoding the image data from the DSP 22, a hard disk 24 storing the encoded image data from the encoder 23, a decoder 25 decoding encoded image data reproduced from the hard disk 24, a microcomputer 27 carrying out the control operations of the DVR 300 according to the operator's request, and a memory 28. The DVR 300 can also include other known components such as a monitor/screen, etc. Also, the DVR 300 can be integrated into another device such as a workstation, a desktop computer, etc. All the components of the DVR 300 are operatively configured and coupled.

The DSP 22 includes a change detector 22a for detecting an event of image change according to a condition set on image data. The event of image change according to a prescribed condition corresponds to one of various types of changes detected from image signals, an example of which can be, but is not limited to, a motion or a change of intensity. The change detector 22a can also detect a change according to a condition prescribed for each channel. For example, channel 1 can detect motion, while channel 2 can detect intensity change. In the embodiments below, the description is given to the case of motion detection, which however can be equally applied to, e.g., the case of intensity change (brightness of image signals) and/or the detection of various types of changes from image signals requiring the operator's attention as well.

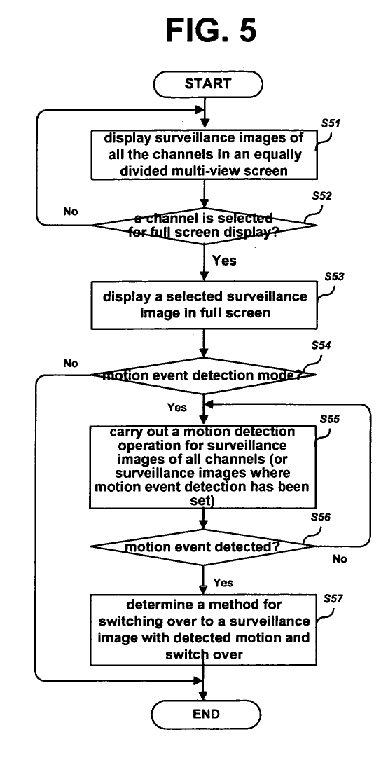

FIG. 5 illustrates a flow diagram of a method for controlling the output of a surveillance image in accordance with one embodiment of the present invention. In the following, the flow diagram of FIG. 5 along with the operation of the DVR 300 having the structure of FIG. 4 is described in detail. The method of FIG. 5 is described as it is implemented by the DVR 300; however, the method can be implemented in other suitable device or system according to the present invention.

Referring to FIGS. 4 and 5, the DVR 300 is connected to multiple surveillance cameras (camera 1, camera 2, . . .) distributed across particular areas where monitoring is desired, and sequentially (or in other way) receives surveillance images 1 provided from the multiple cameras, e.g., through the signal selector 20. The signal selector 20, according to a channel selection signal 2 from the microcomputer 27, selects and outputs surveillance images 1 of input multiple channels (CH1, CH2, CH3, CH4, . . . ) one by one. The AID converter 21 then converts the selected received analog surveillance image to a digital video (or video and audio) signal and provides the digital video signal to the digital signal processor 22.

The digital signal processor 22, according to a control signal 3 received from the microcomputer 27, combines the digital video signal with image data of one or more other channels stored in an internal buffer, which are then provided to a monitor in a format fitted for outputting on the monitor. In order to generate a single output screen by composing the image data of different channels, i.e., to generate a multi-view screen where a surveillance image of each channel occupies at least one sub-screen of the multi-split screen, the DSP 22 stores the digitally converted image signal of each channel in the internal buffer for a prescribed time duration, e.g., the time T during which the channel selection signal 2 passes on all the channels. The buffered image frames at this stage correspond to those selected according to a prescribed sampling period rather than all of the image frames during the time duration T. For example, only one frame can be buffered per one second. Through the procedure above, the surveillance images of all the channels (images updated at a prescribed period) are displayed as partitioned on a single output screen (S51).

When the user has selected a single particular channel among the multiple channels available (S52), the DSP 22, according to a control signal from the microcomputer 27, prepares and outputs a screen consisting of a surveillance image only from the selected channel without combining with the image signals of other channels (S53). That is, among the multiple channels, if the user selects a particular channel to be displayed in a full screen view (S52), the DVR 300 displays in full view the surveillance image only from the selected channel on the entire screen/monitor (S53). For instance, if the current operator has requested the microcomputer 27 for a single surveillance image, e.g., the output of the surveillance image of channel 11, a single surveillance screen, under the control of the microcomputer 27, is displayed on the monitor as shown in FIG. 3. In addition, when the output screen as above is prepared, the DSP 22 can provide a menu screen supporting the input of a user's command or selection, for example, a menu bar is combined with the output screen at the upper or lower part thereof.

If a motion event mode is set at the user's request for all channels or for selected channel(s) (S54), the change detector 22a within the DSP 22 compares subsequent two image frames of each of the corresponding input channel(s) and checks whether a motion (e.g., a change) exists in the corresponding surveillance image, whereby any motion is detected (S55). In the example where a motion event mode is set for only certain channels, the operation for the motion detection is carried out only for those channels where the motion event mode is activated (S55).

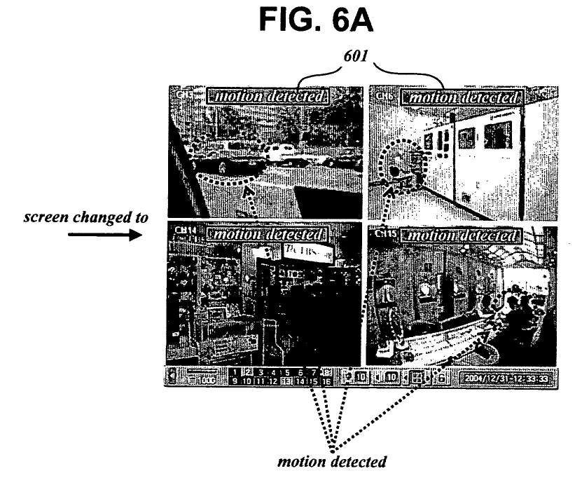

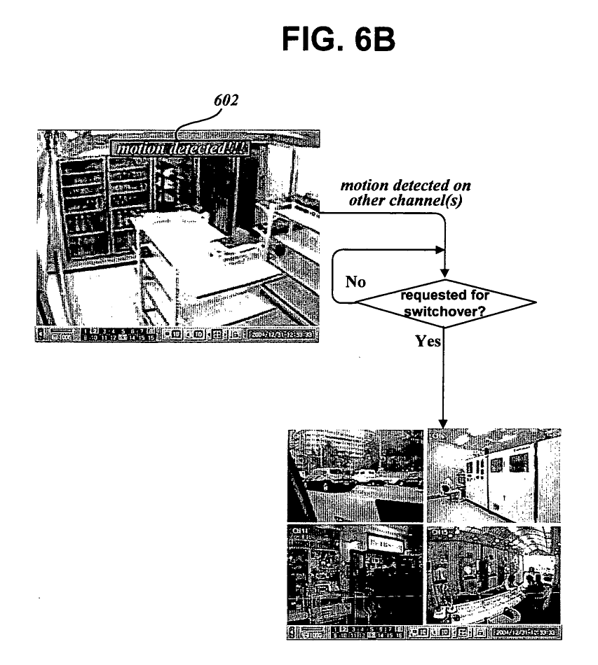

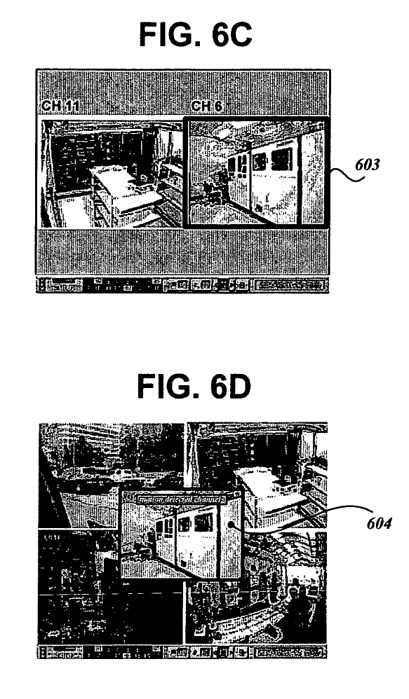

If a motion is detected in a number of channels (e.g., CH3, CH6, CH14, CH15) through the above motion detection operation (which can be the case where the motion detection mode is set for all channels or for only certain channels) (S56), the microcomputer 27 suspends displaying in a full view a current channel, i.e., the output of a surveillance image signal of channel 11 (from step S53), determines an output method for surveillance image signal(s) from the motion detected channel(s), and combines the corresponding surveillance image signals according to the determined method into a single multi-view screen and displays the multi-view screen as shown in FIG. 6A (S57).

For example, if the number of surveillance images (channels) from which any motion is detected is N, the screen is equally divided by N and the surveillance images from those channels are displayed respectively on the divided screen, such that a surveillance image with the detected motion is inserted to each partition of the screen. The example of FIG. 6A illustrates the case when the screen is equally divided into four partitions; however, if a motion is detected in only a single surveillance image/channel, then only the corresponding surveillance image is displayed, which will be on the entire screen.

As shown in FIG. 6A, in order for an operator to easily recognize a motion detection, a character string such as ‘motion detected’ 601 can be made to blink at a particular area, e.g., at the upper area of each partition containing the motion detection (or full screen). In addition, sounds can be generated to alert the operator. Also, such alert information may be viewed/audibly played at a remote terminal, e.g., to alert an operator at or near the surveillance area from which the motion has been detected.

When the motion is detected by the DSP 22, the microcomputer 27 is notified of the detected motion and at the same time, image data (including the data buffered in the channel) of the channel from which the motion is detected are multiplexed and fed to the encoder 23. Channel information and time information (and other desired information) are inserted to each of the multiplexed channels so that image data can not only be separated according to each channel during a subsequent playback, but time information can also be displayed together. The microcomputer 27, according to the notification of motion detection, carries out a control operation needed for the multiplexed data of motion detected image signals fed from the DSP 22 to be recorded. Under the control operation, the encoder 23 encodes image data of each of the multiplexed channels in a predefined format, e.g., MPEG-2 or MPEG-4, after which the image data are stored in the hard disk 24 and/or the memory 28, or in other storage medium.

In another embodiment in accordance with the present invention, even when a motion is not detected, recording of the surveillance image is carried out with a prescribed period, e.g., one frame per 30 seconds. Then, when a motion is detected for the same channel, all the frames of the surveillance image before and after the motion detection are stored in the hard disk 24. For example, image frames that are received and buffered through the signal selector 20 by one frame per second and the received frames during a prescribed time after the motion detection are stored in the hard disk 24 or other storage medium. An operator can control the setting of the DVR 300 to implement such recording as desired or automatically.

According to an embodiment, when no further motion is detected during the above operation, the microcomputer 27 stops the recording operation after a prescribed duration from the last motion detection time, and returns to the state before the switchover of the channel to only the motion-detected channel(s) at step S57, thereby making the previously displayed channel, i.e., the surveillance image of channel 11, be displayed in full screen. In another example of the present invention, the return to a previous screen (i.e., to the full display of the channel 11) can be carried out at the user's request.

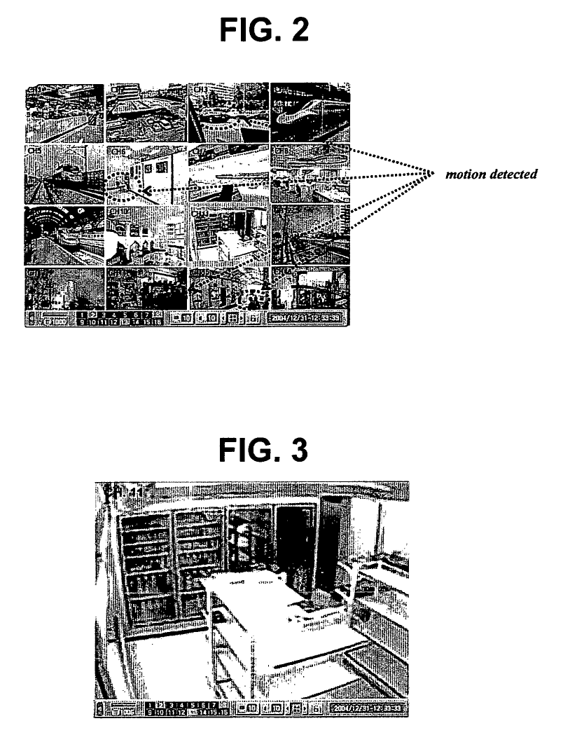

The examples above describe a case where while one channel alone (e.g., channel 11) is monitored, a motion is detected in the surveillance image of one or more other channels. However, the invention can be equally applied to a case of a multi-view output rather than a single-view output. For example, while multiple channels are monitored and displayed on a multi-view screen as shown in FIG. 2, if a motion is detected in the surveillance image of a channel which is currently not being monitored, namely, a channel which is not part of the current multi-view screen output, the output screen can be automatically switched to the surveillance image(s) of the motion-detected channel(s).

In another example in accordance with the present invention, when a motion is detected in a surveillance image/channel which currently is not being monitored, an automatic switchover to the surveillance image of a channel from which a motion is detected is not carried out. Instead, the switchover is made per the user's request For instance, as shown in FIG. 6B, if the current channel being monitored and displayed on the screen is channel 11 but a motion is detected in another channel (e.g., channels 3, 6, 14 & 1), the current screen (which is displaying the channel 11 area) displays a visual mark 602 indicating that a motion is detected in another channel (or channels) or outputs a warning sound through an audio output means (not shown). Then, when the user requests a switchover in response with the visual mark or warning sound, the output screen is switched over to display the surveillance image(s) of the motion-detected channels 3, 6, 14 and 15, for an examination of the motion-detected areas.

In a yet another example in accordance with the present invention, while the operator monitors the surveillance image of a particular channel (e.g., channel 11) in full screen, if a motion is detected in the surveillance image of a different channel (e.g., channel 6), the DSP 22 of the DVR 300, instead of automatically switching over to display only the surveillance image with the detected motion, combines the surveillance image with the detected motion with the surveillance image of the channel being monitored (no motion detected) in real-time, thereby displaying a single combined screen on the monitor as shown in FIG. 6C. For instance, as shown in FIG. 6C, the screen is split into two for displaying both the channel 11 area and the channel 6 area (motion-detected channel) at the same time. Here, in order for the operator to easily distinguish the surveillance image with the detected motion (channel 6) on the half screen from the other half screen of the surveillance image of the currently monitored channel (channel 11), a graphic sign such as a blinking box 603 or some other indication/sound can be augmented. Likewise, the channel number of the motion-detected channel can be displayed and made to blink on the corresponding split screen. In this regard, various methods can be adopted in order to draw attention of the operator. Thereafter, the operator can select the blinking box 603 to view the channel 6 area in full screen.

The example of FIG. 6C describes the case where, while the surveillance image of a channel is monitored in full screen, a motion is detected in the surveillance image of a different channel. The present invention can equally be applied to a case where, while surveillance images of multiple channels are monitored in a multi-view screen, a motion is detected in the surveillance image of a different channel (or channels), after which is combined with the previous multi-view screen. For instance, the example of FIG. 6D illustrates a case where during the monitoring of the surveillance images of four channels where the surveillance images from the four channels are simultaneously displayed in a multi-view screen style, a motion is detected in another different channel. If so, the surveillance images of the four channels are combined with the surveillance image 604 of the motion-detected channel, thus being displayed on one full screen. Likewise, during the monitoring a single channel, if a motion is detected in the surveillance images of multiple channels, the screen output is then composed of the surveillance images from all these channels and then displayed on the screen. The operator can select the image 604 to view the motion-detected channel in full screen if desired.

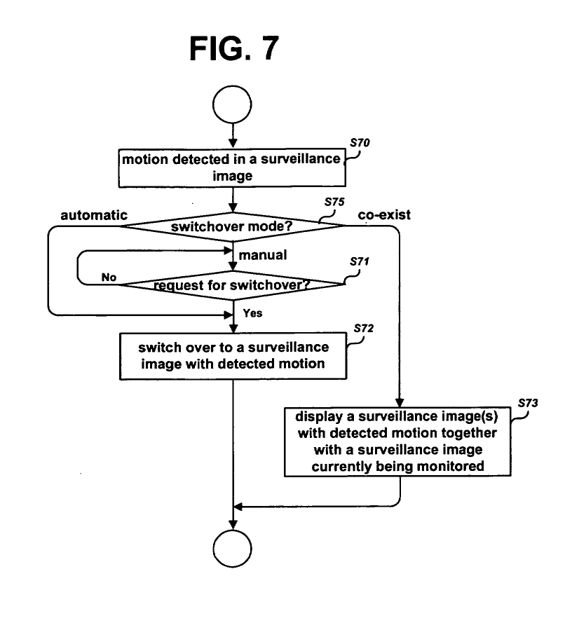

According to the present invention, each method for displaying the surveillance images of channels with detected motions as described in the above examples can be set on the DVR 300 by an operator. FIG. 7 illustrates a method of switching over a display of surveillance images according to various examples of the present invention.

As shown in FIG. 7, when a motion detection mode is set as ‘automatic’ (S75) and as shown in FIG. 6A, a motion is detected in the surveillance image of different channel(s) (S70), the surveillance image being displayed on the screen is automatically switched over to the surveillance image of the motion-detected channel(s) (S72), instead of the currently monitored surveillance image. When a motion detection mode is set as ‘manual’ (S75), as shown in FIG. 6B, the surveillance image being displayed on the screen is switched over to the surveillance image of the motion-detected channel(s) at the operator's request (S71, S72). When ‘co-display’ has been set (S75), as shown in FIG. 6C or 6D, the currently monitored surveillance image and the surveillance image of the motion-detected channel(s) are displayed together on the output screen (S73). The operator can select any of the surveillance images from the displayed channels and display the selected channel in full screen. Also, the DVR 300 provides menus/buttons so that the operator can switch back to displaying only the no-motion-detected channel(s) on the screen, if desired.

By utilizing at least one embodiment/example of the present invention described in detail through the number of embodiments/examples discussed above, the operator can recognize the occurrence of motion not from a recorded image, but from a surveillance image in real-time, thereby being able to cope with the event promptly. Also, since the switch over to displaying the surveillance images from the motion-detected channel(s) can occur automatically, the operator can effectively and immediately view and investigate the motion-detected channel areas, and thus prevent or minimize crimes, emergencies, and other undesirable events.

The foregoing description of preferred embodiments of the present invention has been presented for purposes of illustration. Thus, those skilled in the art may utilize the invention and various embodiments with improvements, modifications, substitutions, or additions within the spirit and scope of the invention as defined by the following appended claims.

What is claimed is:

1. A method for controlling an output of a surveillance image, comprising:
checking whether an event is detected in at least one inputted surveillance image; and
if the event is detected, determining whether to switch over to a surveillance image in which the event is detected, from a first surveillance image currently being displayed.

2. The method of claim 1, wherein the determining step determines whether to switch over based on a designated mode.

3. The method of claim 1, further comprising:
switching, from the first surveillance image to the surveillance image in which the event is detected, on a screen based on the determination result.

4. The method of claim 3, wherein when the event is detected, the switching is performed in response to an inputted switchover request from a user.

5. The method of claim 1, further comprising:
displaying the first surveillance image together with the surveillance image in which the event is detected.

6. The method of claim 5, wherein the displaying step further displays additional indication information in order for the surveillance image in which the event is detected, to be distinguished from the first surveillance image.

7. The method of claim 1, wherein the determining step further outputs notification information notifying that the event is detected.

8. The method of claim 7, wherein the notification information is represented visually or audibly.

9. The method of claim 1, wherein the first surveillance image and the surveillance image in which the event is detected are respectively from different channels or different image capturing devices.

10. The method of claim 1, wherein in the checking step, the event is an image change corresponding to a motion in a surveillance image.

11. The method of claim 1, wherein the checking step checks whether the event is detected in only a designated surveillance image among a plurality of inputted surveillance images corresponding to different surveillance areas.

12. The method of claim 3, wherein when the event is detected, the switching step is performed automatically.

13. The method of claim 12, wherein the switching step involves replacing the first surveillance image displayed on an entire screen with the event-detected surveillance image on the entire screen.

14. An apparatus for controlling an output of a surveillance image, comprising:
a receiver configured to receive a plurality of surveillance images; and
a processor configured to check whether an event is detected in at least one surveillance image among the received plurality of surveillance images, and if the event is detected, to determine whether to switch over to a surveillance image in which the event is detected, from a first surveillance image currently being displayed.

15. The apparatus of claim 14, further comprising:
a storage unit configured to record the plurality of surveillance images.

16. The apparatus of claim 14, wherein the processor controls switching, from the first surveillance image to the surveillance image in which the event is detected, on a screen based on the determination result.

17. The apparatus of claim 16, wherein when the event is detected, the processor carries out the switching in response to an inputted switchover request from a user.

18. The apparatus of claim 14, wherein the processor displays, on a screen, the first surveillance image together with the surveillance image in which the event is detected.

19. The apparatus of claim 18, wherein in addition to displaying the first surveillance image together with the surveillance image in which the event is detected, the processor also displays, on the screen, additional indication information in order for the surveillance image in which the event is detected to be distinguished from the first surveillance image.

20. The apparatus of claim 14, further comprising:
an output unit configured to visually or audibly notify a user that the event is detected.

21. The apparatus of claim 14, wherein the first surveillance image and the surveillance image in which the event is detected are respectively from different channels or different image capturing devices.

22. The apparatus of claim 14, wherein the event is an image change corresponding to a motion in a surveillance image.

23. The apparatus of claim 14, wherein the processor checks whether the event is detected in only a designated surveillance image among a plurality of inputted surveillance images corresponding to different surveillance areas.

24. The apparatus of claim 16, wherein when the event is detected, the processor carries out the switching automatically.

25. The apparatus of claim 24, wherein the switching involves replacing the first surveillance image displayed on an entire screen with the event-detected surveillance image on the entire screen.
